(19) United States
(12) Patent Application Publication
(10) Pub. No.: US 2008/0040189 A1
(43) Pub. Date: Feb. 14, 2008

(54) Automatic selection of meeting participants

(75) Inventors: Aaron Tong, San Jose, CA (US); Martin R. Eppel, Santa Clara, CA (US)

Correspondence Address: THE LAW OFFICES OF BRADLEY J. BEREZNAK, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/503,627

(22) Filed: Aug. 14, 2006

(51) Int. Cl. G06F 9/46

(52) U.S. Cl. 705/9

(57) ABSTRACT

In one embodiment, a system for scheduling a conference includes a database that stores a list of names of persons in a business group and a server. The server is responsive to input from a user interface that includes an alias of the business group in an invitee field of the meeting. The server is operative to resolve the alias and access the database to retrieve the list of names, and then apply an algorithm to the list of names to select an individual as a representative of the group for the meeting. The server then sends an invitation to attend the meeting to the individual. It is emphasized that this abstract is provided to comply with the rules requiring an abstract that will allow a searcher or other reader to quickly ascertain the subject matter of the technical disclosure.

### FIELD OF THE INVENTION

The present invention relates generally to the fields of data networks and communication systems; more specifically, to systems and methods for automatically selecting representatives of a particular group, alias, or organization to participate in a meeting.

### BACKGROUND OF THE INVENTION

A variety of different features and approaches for scheduling meetings using the electronic transfer of data are known. Typically; scheduling applications store electronic data indicating when participants are available and when they are busy, i.e., unavailable. A person who wants to organize and schedule a meeting may view the available time slots for potential participants to automatically specify a suitable meeting time based on the collective availability of these individuals. As the number of potential participants increases, however, it is often difficult for these applications to identify an available time slot that works for everyone. Although some systems differentiate between required participants and optional participants, additional possibilities are usually not considered when trying to schedule a meeting. For instance, prior art meeting scheduling systems are generally unable to ascertain alternative meeting participants and to invite them instead of the original participant.

Commercially-available IP communication system products such as Cisco's MeetingPlace™ conferencing application allow users to schedule meeting conferences in advance or, alternatively, to set up conferences immediately by dialing out to participant parties. In addition, other scheduling systems, such as the Calendar Facility of Microsoft® Outlook, provide a user with the ability to propose a meeting time to one or more other users. For instance, in the Calendar Facility, the system typically checks the schedule of potential participants and sends a message to each one asking them to attend. One drawback to this system is that each message relates to a single proposed meeting time, to which users are required to respond. If the proposed time is not available for a user, then the meeting organizer has to suggest an alternative time. If there are multiple users invited to the meeting, the chances of finding available time are diminished, and the amount of interaction with the system becomes frustratingly time consuming. One drawback of prior art meeting scheduling systems is that they typically require that the organizer specifically name each of the persons invited to attend the scheduled meeting or conference session. There are times, however, when a meeting organizer simply wants a representative from a particular group or organization to attend the meeting, without a preference for who that individual is. This can occur, for example, when a manager sets up a meeting that involves many cross-functional business units or groups. The manager who is organizing the meeting may not care who attends from each group, so long as at least one person who is knowledgeable and able to speak on behalf of that group attends the meeting or conference session.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a high level network diagram illustrating one embodiment of the present invention.

FIG. 2 is a more detailed network diagram in accordance with one embodiment of the present invention.

FIG. 3 is a flow chart diagram of a method of operation in accordance with one embodiment of the present invention.

FIG. 4 is a block diagram showing the basic architecture of a network device according to one embodiment of the present invention.

### DETAILED DESCRIPTION OF EXAMPLE EMBODIMENTS

In the following description specific details are set forth, such as device types, configurations, specific algorithms, etc., in order to provide a thorough understanding of the present invention. However, persons having ordinary skill in the relevant arts will appreciate that these specific details may not be needed to practice the present invention.

According to one embodiment of the present invention, an automatic participant selection system and method is provided to allow a meeting organizer to invite a representative from a particular group to a meeting without having to specify who that representative person is. The representative is selected by the system in accordance with a predetermined selection algorithm or stored list of preferred invitees. In the context of the present application, a group may comprise a mailing alias, a hierarchical unit, or any specified list or collection of individuals in an enterprise or organization.

An organizer of a meeting or conference session (both terms are used interchangeably in the present application) may invoke the automated participant selection feature in a front-end scheduling application by simply specifying a recognized group name, identifier, or mailing alias in an invitee entry field of a user interface. In one embodiment, a graphical user interface (GUI) includes an invitee field where the group name, address, or mailing alias is entered. The group name, address, or mailing alias may be defined explicitly or implicitly in the user interface. For instance, in one embodiment, the user interface may comprise an interactive voice response (IVR) system that includes one or more menu prompts for determining which group is to be invited, whether the entire group is to be invited, specific individuals, or one or more representatives selected by the system in accordance with a selection algorithm are to be invited.

A conferencing server with a processor subsystem for running a conferencing program utilizes the specified group to automatically find a person within that group who is available to attend the scheduled meeting. The conferencing server may access a list of designated persons who may act as group representatives, and then apply one or more selection algorithms to the list in order to select the appropriate invitee for a particular group. For example, an algorithm may preferentially invite certain designated participants from a group and only use less desirable participants if the more desirable participants decline. Alternatively, a selection algorithm may pick participants on a round-robin basis. In other words, a wide variety of different types of algorithms may be used to select invitees from a particular group.

It is appreciated that at the time the meeting is scheduled, the meeting organizer may not know which representative from a particular group or alias has been invited and accepted the invitation to attend. In one embodiment, after the conferencing server utilizes a selection algorithm to select a representative in a particular group to invite, the server may then notify the meeting organizer and/or all invitees through email, an interactive voice response (IVR) system call, or through any other conventional communications methods.

In a specific embodiment, the present invention may be implemented by software or hardware (firmware) installed in an IP communications system that includes components such as Cisco System's IP Communicator, Call Manager, MeetingPlace™, Softphone (a PC that has phone capabilities installed), and other scheduling and conferencing products. Alternative embodiments of the present invention may be implemented in PBX, telephony, telephone, and other telecommunications systems. Similarly, the signaling path utilized for transmission of commands, messages, and signals for establishing, moderating, managing, and controlling the conference session may be across any network resources. Practitioners in the art will understood that the software or firmware installed in the systems and components mentioned above may be adapted or modified to implement the functions and capabilities described herein.

FIG. 1 is a high level network diagram illustrating one embodiment of the present invention in which a meeting organizer 11 interfaces with a front-end application 12 to organize a meeting. Front-end application 12, by way of example, may comprise an IP communication system product such as Cisco MeetingPlace™, Microsoft® Outlook, Yahoo® Calendar, an IVR system, etc., that has been modified or adapted to implement the scheduling functions and operations described herein. Basically, front-end application 12 allows users to schedule or set-up a meeting or conference session. The scheduled conference session may be for some future time, or, alternatively, on an ad hoc basis where the conference session is immediately established upon dialing out to one or more participant parties. Alternative embodiments of front-end application 12 may be implemented in plug-ins, modules, software or hardware (firmware), and/or enhancements that implement the various features and functions described herein installed in an IP communication system, PBX, telephony, telephone, PC and other computer and telecommunications systems.

Continuing with the example of FIG. 1, front-end application 12 communicates with a back-end application 13, which in one embodiment comprises a server that runs executable code to implement conferencing or meeting functions described herein. In one embodiment, meeting organizer 11 utilizes the front-end application 12 to select a list of meeting participants or conference attendees. Organizer 11 may enter a group name or mailing alias to invite a representative of a particular group.

Back-end application 13 is the entity that actually sets up the meeting or conference session by sending out invitations to the invited participants or individual representatives of particular groups. Back-end application 13 is also responsible for allocating the necessary resources (e.g., audio mixers, channels, etc.) to implement the meeting. In cases where organizer 11 has selected or entered a group name or mailing alias—e.g., a representative from each of groups 15 & 16—back-end application 13 implements a selection algorithm that chooses at least one representative from the designated groups as invitees to the meeting. For example, if organizer 11 entered group names for each of groups 15 & 16 in front-end application 12, back-end application 13 would select at least one individual from each of groups 15 & 16, sending out meeting invitations to each of the selected representatives.

In accordance with the embodiment of FIG. 1, instead of having to designate a person from, say, the corporate Sales Division (e.g., group 15) and another person from, say, the corporate Marketing Division (e.g., group 16) as the representatives to attend the meeting, organizer 11 may simply invite (through a user interface of front-end application 12) representatives from the Sales and Marketing Divisions to the meeting using defined group names or aliases. Recognizing the predefined group names or aliases as invitees of the meeting, back-end application 13 may then run an algorithm to select an appropriate representative from each of groups 15 & group 16 to attend the meeting.

Continuing with the above example, back-end application 13 (e.g., conferencing server) may divide the groups into different subclasses (e.g., West Coast Sales and East Coast Sales). In accordance with a specific selection algorithm back-end application 13 may follow a set of preferences regarding choosing a representative from Sales to attend the meeting. For example, the selection algorithm may dictate that a representative from the West Coast Sales division is selected as a first choice. The algorithm may have a hierarchical list of preferred meeting representatives to choose from. If the first person on the list declines the meeting invitation sent by back-end application 13, then back-end application 13 may send an invitation to attend the meeting to a second person on the list, and so on.

In a specific implementation, back-end application 13 may send out multiple invitations to listed representatives, or invitations to everyone listed as a potential representative in the group. The first person in the group to accept the invitation is then designated as group representative for the meeting by back-end application 13. Upon acceptance, back-end application 13 may cancel the invitation to the remaining persons in the group that were sent an invitation. In other words, the back-end server application may send a message to each of the other persons in the group that they are no longer needed for the meeting and that they should consider their invitation cancelled. In another implementation, back-end application 13 proceeds by sending a single invitation to a person listed as eligible for representing the group and then wait for that person to accept or decline the invitation. If the person declines or fails to respond in a timely manner, the selection algorithm selects another person from the list of eligible representatives. In the event that nobody from the West Coast Sales division is available to attend the meeting scheduled by organizer 11, the selection algorithm may proceed to try to secure a commitment from someone from the East Coast Sales division to attend.

Practitioners in the art will appreciate that a wide variety of preference rules may be utilized and applied in the process of choosing a representative from a particular group. In addition, different rules or selection algorithms may be utilized for different groups recognized by back-end application 13. In other words, one selection algorithm may be utilized by back-end application 13 to select a meeting representative from group 15, with a different selection algorithm being used to select a meeting representative from group 16.

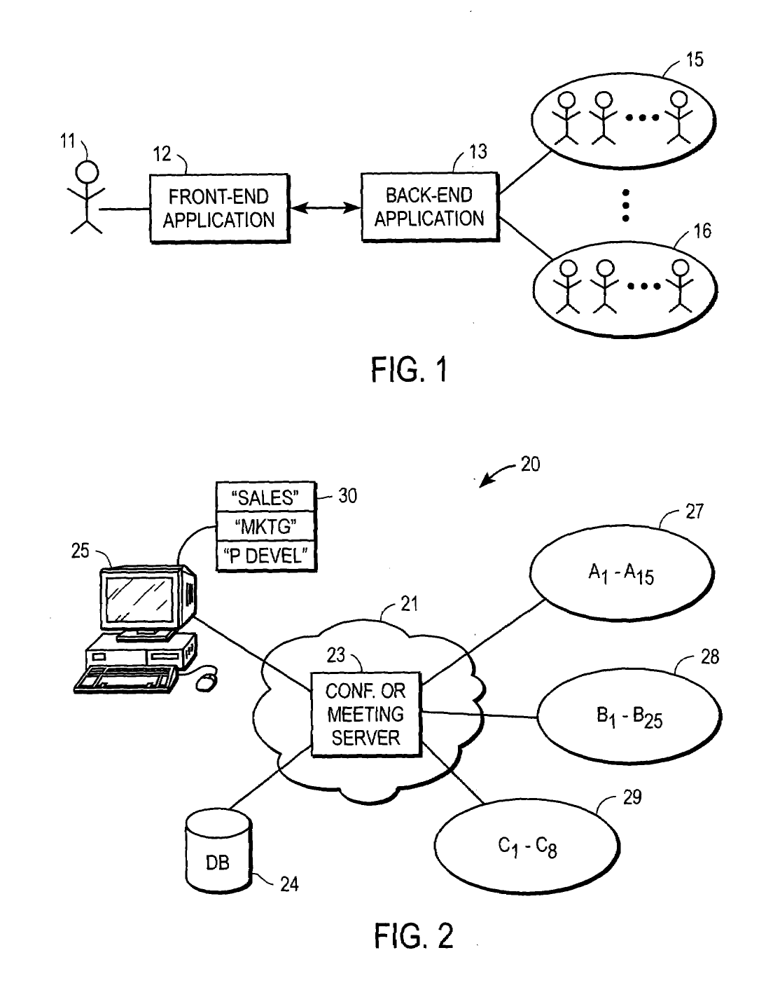

FIG. 2 is a network diagram in accordance with another embodiment of the present invention in which the front-end scheduler application discussed above resides locally on a personal computer (PC) 25. Alternatively, the meeting scheduler application may be located elsewhere on network 21 and accessed by PC 25. Network 21 may comprise a corporate network (intranet), the Internet, a wireless network, or any other type of network capable of providing a backbone for the communications described herein. When an organizer using wants to set up a meeting, a graphical user interface (GUI) may be invoked on PC 25 that provides the user/organizer with the ability to schedule a meeting with a list of invited participants. The GUI may be generated by software (i.e., code) running the user's PC. In other cases, the GUI may comprise a collaborative web-based application that is accessed by the browser software running on the user's PC. For instance, the scheduling GUI may reside on a scheduling application running on a server, with the GUI being accessed by PC 25 via network 21 In other instances, GUI may comprise a downloaded application, or other forms of computer-executable code that may be loaded or accessed by PC 25.

In one implementation, the scheduler GUI may prompt the organizer using PC 25 to select one or more participants to be invited to the meeting. The GUI may include an entry field that permits a user to enter any of a set of predefined group names or mailing aliases contained in an alias list 30, or simply enter the names or email addresses of individuals to be invited to attend the meeting. In the embodiment illustrated by FIG. 2, alias list 30 includes the group names “SALES,” “MKTG,” and “P DEVEL” corresponding to designated Sales, Marketing, and Product Development groups or divisions within the organization. In other words, by entering one of these alias names in the meeting invitee entry field of the GUI running on PC 25, a meeting organizer basically delegates to the conference or meeting server 23 the task of selecting a representative from the corresponding group

By way of example, the groups 27-29 shown in FIG. 2 may respectively correspond to the Sales, Marketing, and Product Development groups that may be referenced by the aliases included in list 30. It should be understood that a wide variety of groups, subgroups, and even other organizations may be instantiated or referenced by an alias included in list 30. For instance, an alias “ACME” may be used to designate Acme, Inc., an outside contractor to the organization, such that entry of “ACME” in the meeting invitee entry field of the GUI running on PC 25 results in conferencing server 23 sending out an invitation to one or more persons of Acme, Inc., to attend the meeting as a representative of the outside organization.

After the organizer has completed the process of setting up a scheduled meeting, the list of attendees, including any entered group names, aliases, mailing addresses, etc. is resolved by conference/meeting server 23. In cases where the list of meeting invitees includes one or more group names (from list 30) server 23 may access a database 24 to acquire corresponding lists of designated representatives for each group, as well as fetch a corresponding selection algorithm(s) to be used in selecting one or more persons of a particular group to be invited to the meeting. For example, in the case where the organizer has entered the “SALES”, “MKTG”, and “P DEVEL” aliases in the invitee entry field of the scheduler application, conferencing server 23 may access database 24 to obtain a list of designated representatives as well as a selection algorithm for use in selecting/inviting one or more representatives—e.g., persons (A₁-A₁₅), (B₁-B₂₅), and (C₁-C₁₅)—from groups 27-29, respectively.

The invitation to representative persons selected to attend the scheduled meeting may be sent via email, instant messaging (IM), an IVR menu system, or any other appropriate medium/mode for communicating with the selected invitees. In accordance with a specific type of selection algorithm, in the event that an invited representative of a particular group fails to timely respond (e.g., the first choice from a hierarchical list of representatives) conferencing server 23 may proceed to select another representative (e.g., the second choice) from that group, and so on. As discussed previously, conferencing server 23 may alternatively invite everyone from a particular and then wait to receive an acceptance response from someone. In still other cases, the selection algorithm may implement a routine wherein persons are selected as representatives on a round-robin basis.

In still other embodiments, the selection algorithm may analyze other content fields (e.g., the meeting subject field) and use information obtained from those fields as part of the selection process. For example, the selection algorithm may be such that if the word “budget” appears in the subject or other content fields, then the selection algorithm will only invite a certain person (e.g., a comptroller or other person with budgeting authority) from a particular group. In another instance, if the word “confidential’ appears anywhere in the subject field of the scheduled meeting, the selection algorithm may only invite persons at a managerial or director level (and above) to the meeting. In the later example, should the invited person(s) decline the invitation to attend, the selection algorithm may notify the organizer (via email) that a representative from the group has declined the invitation or is otherwise unable to attend, rather than attempt to find another person from that group.

In certain embodiments, members of a particular group may designate themselves as representatives via direct communications with conferencing server 23, which then stores that information in database 24. In such cases, conferencing server 23 will apply a selection algorithm only to those designated members who have indicated they want to be considered as representatives. Conversely, members of groups 27-29 may indicate to conferencing server 23 that they do not want to be considered as representatives. In response, conferencing server 23 may automatically exclude those particular members when running a selection algorithm to choose one or more representatives from that group for a particular meeting or conference session.

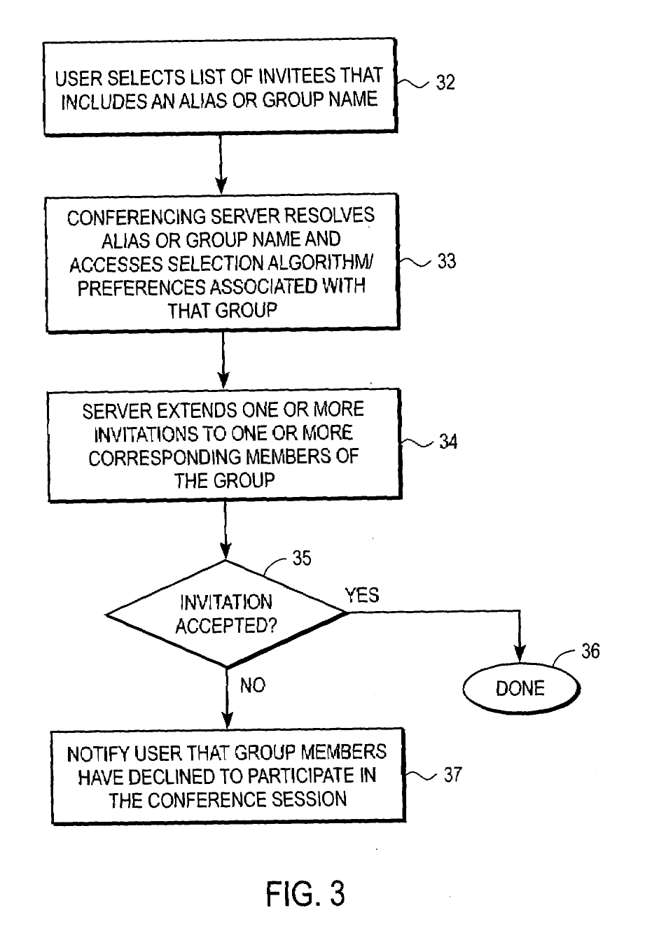

FIG. 3 is a flow chart diagram of a method of operation in accordance with one embodiment of the present invention. The process begins at block 32 with the selection by a user/organizer of a list of invitees to a meeting, the list including an alias or group name that is then transferred or provided to the back-end conferencing server. Upon receiving the list of participants and aliases from the scheduler, the conference server resolves each alias or group name and accesses a database containing a list of potential representatives associated with the corresponding group along with one or more selection algorithms and/or preferences to be applied to the list of individuals (block 33).

At this point, the conferencing server executes the selected algorithm(s) to select one or more persons in the group to be invited to participate in the conference session. Once the selection algorithm has completed, one or more invitations are sent by the conferencing server to one or more members of a particular group (block 34). Note that the invitations may be sent by any available communication system or method, with the particular means of communication being specified by user preference files associated with the individual invitees.

In the event that the conferencing server receives an invitation acceptance (block 35) from a group representative, the process with respect to that particular group is basically done (block 36). If, on the other hand, the invitation is declined, the system may, in accordance with the selection algorithm in use, attempt to invite other persons from the group until an acceptance is received. In the event that the conferencing system does not receive an invitation acceptance from any person listed as an appropriate representative for the particular group, an email (or IM, or IVR message, etc.) is sent to the meeting organizer notifying him that the group members have declined to participate in the conference session (block 37).

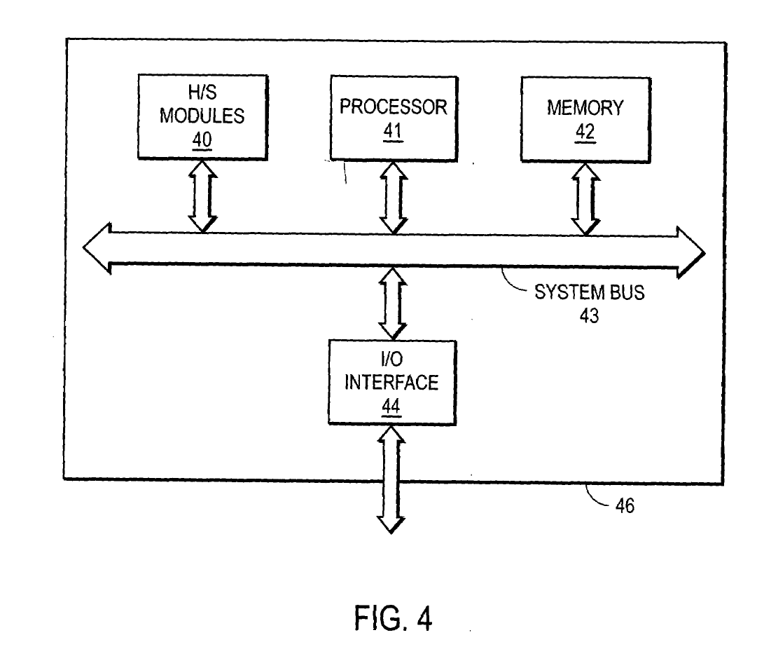

FIG. 4 is a generalized block diagram showing an example network device 46, such as may comprise any of the devices shown or described in conjunction with FIG. 1 or 2. Device 46 includes a processor subsystem 41 coupled with a memory unit 42, one or more hardware/software modules 40, and an input/output (I/O) interface 44 via a system bus 43. Modules 40 may include software or hardware (firmware) for implementing any of the functions described herein, e.g., those functions associated with scheduling or handling a conference session, including selection of group representatives based on a group name or mailing alias. It is appreciated that any IVR system utilized by device 46 may comprise separate hardware devices coupled to the system bus 43, or, alternatively, implemented as software programs or modules 40 that run on one or more processors of subsystem 41. In other words, the scheduler, user interface, conference management, and other functions may be implemented as separate hardware devices, memory locations (storing executable code), firmware devices, software modules, or other machine-readable devices. (In the context of the present application, therefore, the term “module” is to be understood as being synonymous with both hardware devices and computer-executable software code, programs or routines.)

It should be understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer or telephonic device to a requesting process by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. For instance, although functions and elements of the present invention have been described as being embodied on a scheduling and/or conferencing application, client, or server, it is appreciated that these same elements and functions may be embodied on an email server or client, or other types of applications, clients, or servers. Accordingly, the specification and drawings are to be regarded in an illustrative rather than a restrictive sense.

We claim:

1. A method comprising:
receiving a list of attendees for a conference session, the list including an alias associated with a group of individuals;
applying an algorithm to select a particular individual to represent the group in the conference session; and
sending an invitation to participate in the conference session to the particular individual selected by the algorithm.

2. The method of claim 1 wherein the one or more individuals are selected from a subset of the individuals who have been designated to represent the group.

3. The method of claim 1 further comprising:
receiving a message sent by the particular individual declining the invitation;
selecting a different individual to represent the group in accordance with the algorithm; and
inviting the different individual to participate in the conference session.

4. The method of claim 1 wherein the list of attendees for the conference session comprises a set of mailing addresses, with the alias comprising a predefined mailing alias.

5. The method of claim 1 further comprising:
notifying an organizer of the conference session that the group or the particular individual has declined the invitation to participate in the conference session.

6. A method comprising:
resolving an alias associated with a group of individuals input to a scheduling application for scheduling a conference session;
accessing a database to retrieve a list of names of individuals in the group; and
applying a selection algorithm to the list of names to select one or more of the individuals as a representative of the group in the conference session; and
inviting each of the one or more individuals to attend the conference session.

7. The method of claim 6 wherein the one or more individuals is a first individual and further comprising:
receiving a message sent by the first individual declining the invitation;
selecting a second individual in accordance with the selection algorithm; and
inviting the second individual to attend the conference session.

8. The method of claim 6 wherein the database comprises a memory associated with a conferencing server.

9. Logic encoded in one or more media for execution and when executed is operable to:
resolve an alias associated with a group of individuals;
access a database to retrieve a list of names of individuals in the group; and
apply a selection algorithm to the list of names to select a particular individual as a representative of the group in a conference session; and
invite each of the one or more individuals to attend the conference session.

10. The logic of claim 9 wherein the alias is input to a scheduling application for scheduling the conference session.

11. The logic of claim 9 wherein the media, when executed, is further operable to:
receive a message sent by the first individual declining the invitation;
select a second individual in accordance with the selection algorithm; and
invite the second individual to attend the conference session.

12. Logic encoded in one or more media for execution and when executed is operable to:
resolve an alias associated with a group of individuals;
access a database to retrieve a list of names of individuals in the group; and
send an invitation to attend a conference session to each of the individuals;
cancel invitations sent to all but a first one of the individuals in response to the first one accepting the invitation.

13. The logic of claim 12 wherein the media, when executed, is further operable to:
notify an organizer of the conference session that the group has declined attend the conference session in response to all of the individuals either declining the invitation or failing to affirmatively accept the invitation in a timely manner.

14. The logic of claim 12 wherein the database comprises a memory associated with a conferencing server.

15. The logic of claim 12 wherein the alias is input to a scheduling application for scheduling the conference session.

16. A system comprising:
a database that stores a list of names of persons in a business group;
a server responsive to input from a user interface that includes an alias of the business group in an invitee field of a meeting, the server being operative to resolve the alias and access the database to retrieve the list of names, the server being further operative to apply an algorithm to the list of names to select an individual as a representative of the group for the meeting, and send an invitation to attend the meeting to the individual.

17. The system of claim 16 wherein the server comprises a meeting or conferencing server and the user interface is associated with a scheduling application.

18. The system of claim 16 wherein the user interface comprises a graphical user interface.

19. The system of claim 16 wherein the user interface comprises an interactive voice response (IVR) system.

20. The system of claim 16 wherein selection of the individual by the algorithm is dependent upon information in a content field input from the user interface.

21. The system of claim 16 wherein the server is further operable to select a different individual as the representative of the group in response to a message received from the individual declining the invitation, and to send a new invitation to attend the meeting to the different individual.

22. A system comprising:
a database that stores a list of names of persons in a business group;
means responsive to input from a user interface that includes an alias of the business group in an invitee field of a meeting, the means for resolving the alias and for accessing the database to retrieve the list of names, the means also for selecting an individual as a representative of the group for the meeting, and for sending an invitation to attend the meeting to the individual.
